(19) United States
(12) Patent Application Publication
(10) Pub. No.: US 2026/0067979 A1
(43) Pub. Date: Mar. 5, 2026

(54) MODULAR DESIGN OF RADIO RESOURCE CONTROL FOR RADIO ACCESS TECHNOLOGY

(71) Applicant: Lenovo (United States) Inc., Morrisville, NC (US)

(72) Inventors: Hyung-Nam CHOI, Ottobrunn (DE); Joachim LÖHR, Wiesbaden (DE); Tapisha SONI, Munich (DE)

(21) Appl. No.: 19/380,320

(22) Filed: Nov. 5, 2025

(51) Int. Cl. H04W 76/27; H04W 76/10

(52) U.S. Cl. CPC H04W 76/27; H04W 76/10

(57) ABSTRACT

Various aspects of the present disclosure relate to a User Equipment (UE) configured to or operable to generate a first message according to an Abstract Syntax Notation One (ASN.1) module and one or more ASN.1 sub-modules, wherein the ASN.1 module comprises information irrespective of features applicable to the UE, and wherein the one or more ASN.1 sub-modules comprises information respective to one or more features applicable to the UE, transmit, to a network entity, the first message, wherein the first message includes information respective to the one or more features applicable to the UE and excludes other information respective to one or more features inapplicable to the UE and receive, from the network entity, a second message based at least in part on the transmitted first message.

### TECHNICAL FIELD

The present disclosure relates to wireless communications, and more specifically to a modular Abstract Syntax Notation One (ASN.1) structure.

### BACKGROUND

A wireless communications system may include one or multiple network communication devices, otherwise known as network equipment (NE), supporting wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like)). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., 5G-Advanced (5G-A), sixth generation (6G), etc.).

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

The apparatuses (e.g., NE, UE), processors, and methods of the present disclosure each have several innovative aspects, no single one of which is solely responsible for the desirable features disclosed herein.

A UE for wireless communication is described. The UE may be configured to, capable of, or operable to perform one or more operations as described herein. For example, the UE may be configured to, capable of, or operable to generate a first message according to an Abstract Syntax Notation One (ASN.1) module and one or more ASN.1 sub-modules, wherein the ASN.1 module comprises information irrespective of features applicable to the UE, and wherein the one or more ASN.1 sub-modules comprises information respective to one or more features applicable to the UE, transmit, to a network entity, the first message, wherein the first message includes information respective to the one or more features applicable to the UE and excludes other information respective to one or more features inapplicable to the UE, and receive, from the network entity, a second message based at least in part on the transmitted first message.

A method performed or performable by a UE for wireless communication is described. The method may include generating a first message according to an ASN.1 module and one or more ASN.1 sub-modules, wherein the ASN.1 module comprises information irrespective of features applicable to the UE, and wherein the one or more ASN.1 sub-modules comprises information respective to one or more features applicable to the UE, transmitting, to a network entity, the first message, wherein the first message includes information respective to the one or more features applicable to the UE and excludes other information respective to one or more features inapplicable to the UE, and receiving, from the network entity, a second message based at least in part on the transmitted first message.

In some implementations of the UE, and the method described herein the received second message includes the information respective to the one or more features applicable to the UE and excludes other information respective to the one or more features inapplicable to the UE.

In some implementations of the UE, and the method described herein, the UE determines that the information respective to the one or more features applicable to the UE, and associated with the one or more ASN.1 sub-modules, is absent from the second message, and discards the second message in response to the determination.

In some implementations of the UE, and the method described herein, the UE selects the one or more ASN.1 sub-modules based at least in part on the one or more features applicable to the UE, wherein the first message is generated based at least in part on the selected one or more ASN.1 sub-modules.

In some implementations of the UE, and the method described herein, the UE determines UE capability information, wherein the one or more ASN.1 sub-modules is selected based at least in part on the UE capability information, and the second message is based at least in part on the UE capability information.

In some implementations of the UE, and the method described herein, the UE includes a protocol stack comprising processor-executable code, the protocol stack comprises at least a Radio Resource Control (RRC) protocol layer, and to generate the first message, the UE generates the first message according to the ASN.1 module and the one or more ASN.1 sub-modules.

In some implementations of the UE, and the method described herein, the ASN.1 module comprising information irrespective of the one or more features applicable to the UE corresponds to definitions of messages and Information Elements (IEs) common for UEs.

In some implementations of the UE, and the method described herein, the one or more features applicable to the UE and associated with the one or more sub-modules comprises one or more of: a set of one or more UE-specific features supported by the UE; a set of one or more modes of the UE, including at least one of an idle mode, an inactive mode, or a connected mode; a type of the UE; a cast type supported by the UE, including at least one of unicast, multicast, or broadcast; and a radio access technology (RAT) supported by the UE.

In some implementations of the UE, and the method described herein, the set of one or more UE-specific features supported by the UE comprises one or more of a machine learning (ML)-enabled feature, intra-band Carrier Aggregation (CA), inter-band CA, Multiple Input Multiple Output (MIMO)-enabled transmission or reception, intra-Radio Access Technology (RAT) mobility, inter-RAT mobility, a channel bandwidth, a modulation order, a number of MIMO layers, or a Transport Block (TB) size.

In some implementations of the UE, and the method described herein, one or more of the first message and the second message associated with the ASN.1 module includes RRCRelease, RRCSetup, or SystemInformation, and one or more of the first message and the second message associated with the one or more ASN.1 sub-modules includes RRCReconfiguration, RRCConfigurationRelease, or UECapabilityInformation.

In some implementations of the UE, and the method described herein, the first message includes a first indication of the one or more ASN.1 sub-modules, and wherein the second message includes a second indication of the one or more ASN.1 sub-modules.

An NE (e.g., a base station) for wireless communication is described. The NE may be configured to, capable of, or operable to perform one or more operations as described herein. For example, the NE may be configured to, capable of, or operable to generate a first message according to an ASN.1 module and one or more ASN.1 sub-modules, wherein the ASN.1 module comprises information irrespective of features applicable to a UE, and wherein the one or more ASN.1 sub-modules comprises information respective to one or more features applicable to the UE, transmit, to the UE, the first message, wherein the first message includes information respective to the one or more features applicable to the UE and excludes other information respective to one or more features inapplicable to the UE, and receive, from the UE, a second message based at least in part on the transmitted first message.

In some implementations of the NE, the processor-executable code stored by the NE includes code for a plurality of sub-modules, and the NE selects the one or more sub-modules from the plurality of sub-modules based on the one or more features applicable to the UE.

### BRIEF DESCRIPTION OF THE DRAWINGS

FIG. 1 illustrates an example of a wireless communications system in accordance with aspects of the present disclosure.

FIG. 2 illustrates an example of an NR RRC message.

FIG. 3 illustrates an example of a definition of the System Information Block (SIB) SIB6 IE in ASN.1.

FIG. 4 illustrates an example of the ASN.1 structure for NR RRC.

FIG. 5 illustrates an example of a modular ASN.1 structure in accordance with aspects of the present disclosure.

FIG. 6 illustrates an example of a lean RRC message in accordance with aspects of the present disclosure.

FIG. 7 illustrates an example of a modular ASN.1 structure in accordance with aspects of the present disclosure.

FIG. 8 illustrates an example of sub-module specific RRC messaging in accordance with aspects of the present disclosure.

FIG. 9 illustrates an example of a UE capability information response message in accordance with aspects of the present disclosure.

FIG. 10 illustrates an example of a radio resource (re)configuration message in accordance with aspects of the present disclosure.

FIG. 11 illustrates an example of a radio resource configuration release message in accordance with aspects of the present disclosure.

FIG. 12 illustrates an example of a UE in accordance with aspects of the present disclosure.

FIG. 13 illustrates an example of a processor in accordance with aspects of the present disclosure.

FIG. 14 illustrates an example of an NE in accordance with aspects of the present disclosure.

FIG. 15 illustrates a flowchart of method performed by a UE in accordance with aspects of the present disclosure.

FIG. 16 illustrates a flowchart of method performed by an NE in accordance with aspects of the present disclosure.

### DETAILED DESCRIPTION

Wireless communication technologies have progressively evolved from earlier radio access technologies such as 3G and 4G to 5G, with each generation introducing advancements in throughput, latency, and reliability for wireless communications. Evolving from 5G, 6G is envisioned to further enhance performance through higher throughput, reduced latency, and improved reliability. Wireless communication systems supporting 6G are also expected to natively integrate sensing and AI-related capabilities and functionalities, extend coverage and connectivity for an increasingly diverse set of devices, from simple Internet of Things (IoT) devices with limited functionality and capabilities to more sophisticated devices such as Extended Reality (XR) devices supporting advanced features and capabilities.

Beyond improvements in throughput, latency, and reliability, 6G is expected to expand the types of services supported by wireless communication systems. The supported service may include, but is not limited to: mobile broadband for high-speed broadband access; immersive communication for handling mixed traffic of video, audio, haptic and other environment data in a reliable and synchronous manner; massive communication for enabling transmission of small data volumes to and from a large number of IoT devices; sensing services that utilize sensor data for purposes such as object detection and tracking (e.g., for Unmanned Aerial Vehicles (UAV), Automated Guided Vehicles (AGV), or pedestrians), positioning (e.g., for improved accuracy), wireless communication enhancement (e.g., improved beam management), environment monitoring, digitalization, or reconstruction, and motion monitoring. Other services that may be supported by 6G include voice services; AI-enabled services supporting AI and Machine Learning (ML)-related applications such as AI agents, chatbots, and autonomous driving; and regulatory or public-safter services such as emergency calls, Commercial Mobile Alert System (CMAS), Earthquake and Tsunami Warning System (ETWS), Multimedia Priority Service (MPS) and Mission Critical Services (MCS).

As the diversity of 6G services and device types increases, to support such diversity in services and device types, the radio interface protocol architecture for 6G may include a user plane (U-plane) and control plane (C-plane) protocol stack configured to accommodate service-specific requirements such as payload size, latency, reliability and throughput. In the C-plane, the protocol stack may include a Physical (PHY) protocol layer, one or more Layer 2 (e.g., Medium Access Control (MAC) protocol layer, Radio Link Control (RLC) protocol layer, Packet Data Convergence Protocol (PDCP) layer, etc.), and an RRC protocol layer. Both NE and UE may be configured with respective protocol stacks, each configured with one or more of these protocol layers for handling both signaling of messages between the NE and the UE. For example, the RRC protocol layer at each of the NE and UE may handle, in part, signaling of messages between the NE and the UE. In wireless communication systems deploying 6G, the signaling of messages (e.g. RRC messages) between the NE and the UE may be defined using ASN.1 as specified in International Telecommunications Union-Telecommunications Sector (ITU-T) Rec. X.680 and X.681. However, the current Abstract Syntax Notation One (ASN.1) framework for messages (e.g., RRC messages) as defined in 3rd Generation Partnership Project (3GPP) Technical Specification (TS) 38.331, “NR; Radio Resource Control (RRC); Protocol Specification,” contains several limitations that might limit message handling efficiency in wireless communication systems deploying 6G.

In the current ASN.1 framework, a single main module is defined from which all other modules import IEs and constants. As a result, UEs operating in accordance with 5G are required to compile the entire main module, even when supporting only a subset of features associated with (e.g., defined in) the main module. Over time, the main module has increased significantly in size due to the continuous introduction of new features, and in some cases can reach several megabytes. Consequently, some RRC messages may contain a large amount of overhead and, in some cases, may exceed the RRC Protocol Data Unit (PDU) size limit of 9000 octets, such that those RRC messages may require segmentation prior transmission. This excessive size has been observed in at least the RRCReconfiguration, RRCResume and UECapabilityInformation messages.

Various aspects of the present disclosure provide an advanced modular ASN.1 framework for RRC messages in 6G (also referred to herein as 6G RRC ASN.1 structure). Specifically, one or more aspects of the present disclosure may enable UEs to use only a limited set of modules (e.g., ASN.1 modules) corresponding to features applicable to those UEs. The modular ASN.1 framework allows each UE to store and execute code (e.g., instructions executable by one or more processors of each UE) associated with the features applicable to the UEs, thereby reducing processing and memory overhead related to RRC message handling. The modular ASN.1 framework may be forward-compatible, such that new features for 6G or enhancements of existing features (e.g., 5G features) may be included either as separate sub-modules (e.g., ASN.1 sub-modules) or incorporated into an existing sub-module. As a result, the size of RRC messages may be significantly reduced compared to conventional RRC messages, thereby improving efficiency, preserving resources, and avoiding segmentation of RRC messages.

Although the present disclosure describes various aspects in context of 6G, it should be understood that the disclosed aspects may be implemented in other suitable radio access technologies such as 5G and beyond 6G.

Aspects of the present disclosure are described in the context of a wireless communications system. Aspects of the present disclosure are further set forth in the accompanying drawings and the description below. The description set forth herein, in connection with the accompanying drawings, describes example implementations and does not represent all the implementations that may be implemented or that are within the scope of the claims. The detailed description includes specific details for the purpose of providing an understanding of the described implementations. These implementations, however, may be practiced without these specific details. Additionally, the description set forth herein, in connection with the accompanying drawings is provided to enable a person having ordinary skill in the art to make or use the present disclosure. Various modifications to the disclosure will be apparent to a person having ordinary skill in the art, and the generic principles defined herein may be applied to other variations without departing from the scope of the present disclosure. Thus, the present disclosure is not limited to the examples and implementations described herein but is to be accorded the broadest scope consistent with the principles and novel features disclosed herein.

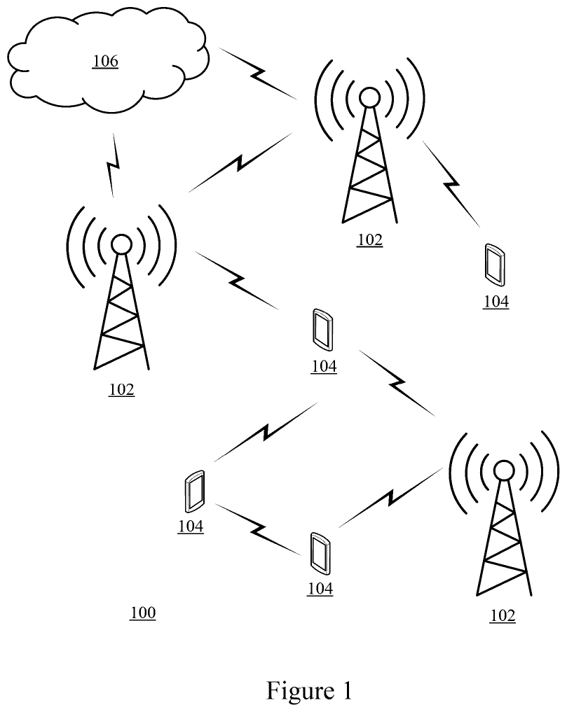

FIG. 1 illustrates an example of a wireless communications system 100 in accordance with aspects of the present disclosure. The wireless communications system 100 may include one or more NE 102, one or more UE 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be an NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NE 102 may be dispersed throughout a geographic region to form the wireless communications system 100. One or more of the NE 102 described herein may be or include or may be referred to as a network node, a base station, a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UE 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, or network interface). In some implementations, the NE 102 may communicate with each other directly. In some other implementations, the NE 102 may communicate with each other indirectly (e.g., via the CN 106). In some implementations, one or more NE 102 may include subcomponents, such as an access network entity, which may be an example of an access node controller (ANC). An ANC may communicate with the one or more UEs 104 through one or more other access network transmission entities, which may be referred to as radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management function (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signaling bearers, etc.) for the one or more UEs 104 served by the one or more NE 102 associated with the CN 106.

The CN 106 may communicate with a packet data network over one or more backhaul links (e.g., via an S1, N2, or another network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0,μ=1,μ=2, μ=3,μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

In the wireless communication system, RRC messaging between a UE 104 and an NE 102 (e.g., a base station) may be defined using ASN.1 as specified in ITU-T Recommendations X.680 and X.681. ASN.1 defines the syntax of RRC messages exchanged between the UE 104 and the NE 102 without imposing constraints on how the RRC messages are encoded for transmission.

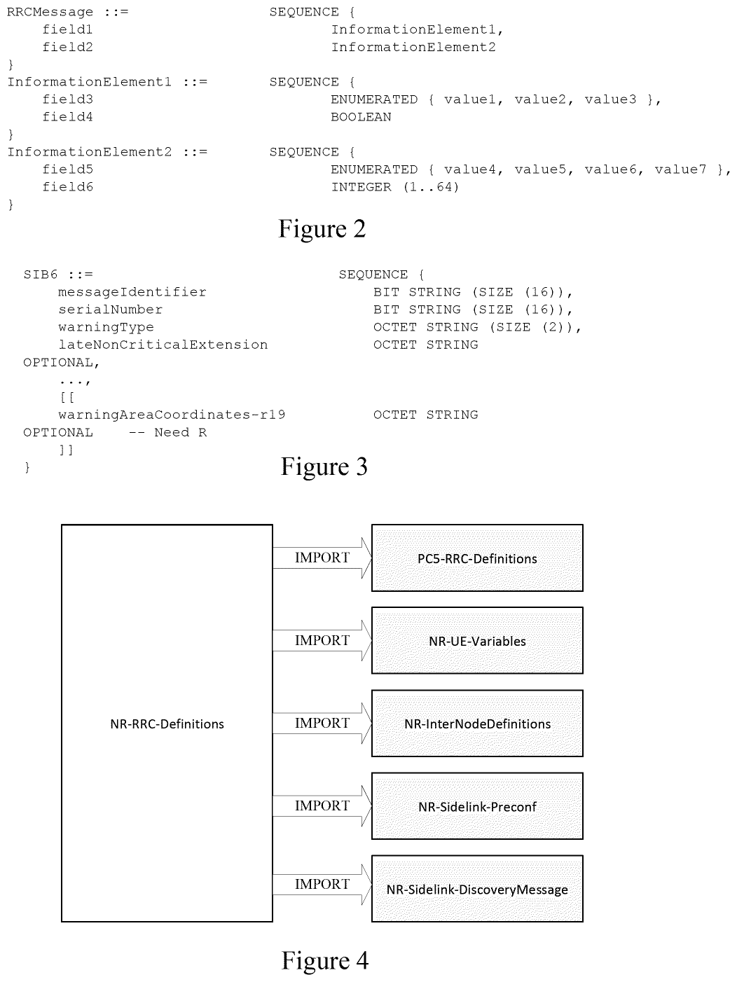

FIG. 2 illustrates an example of an RRC message definition in accordance with aspects of the present disclosure. In the example of FIG. 2, an RRC message named RRCMessage is defined as a SEQUENCE (i.e., an ordered list) of two components, field1 and field2, using the ASN.1 assignment operator “::=”. The scope of the SEQUENCE is demarcated by curly brackets. Each component within the SEQUENCE is associated with (e.g., assigned) a corresponding type that specifies permissible values for each component, such as InformationElement1 for field1 and InformationElement2 for field2. According to ASN.1 syntax, component identifiers (e.g., names) begin with lowercase letters, while the type identifiers (e.g., names) begin with uppercase letters.

ASN.1 allows the use of built-in types as well as the definition of new, more complex types. ASN.1 provides several built-in types, including BOOLEAN, INTEGER, BIT STRING, OCTET STRING, ENUMRATED, SEQUENCE, SEQUENCE OF, and CHOICE. In the example of FIG. 2, the types InformationElement1 and InformationElement2 are defined as new types constructed from the built-in types, such as SEQUENCE, ENUMERATED, BOOLEAN, and INTEGER. In some examples, when the RRC message is transmitted in downlink (DL), an NE 102 may configure the UE 104 with specific values for field1 and field2. In this example, field3 may be assigned the value “value1” and field4 the Boolean value TRUE; while field5 may be assigned the value “value6”and field6 an INTEGER value “8”.

FIG. 3 illustrates an example of a SIB IE definition in accordance with aspects of the present disclosure. In the example of FIG. 3, a SIB6 IE is defined in accordance with ASN.1. The SIB6 IE is used to broadcast (e.g., transmit, receive) ETWS primary notifications in a cell (e.g., a coverage area served by an NE 102) via the SystemInformation message. The SIB6 IE includes the following information: messageIdentifier, which identifies the source and type of ETWS notification; serialNumber, which identifies variations of an ETWS notification; warningType, which identifies the warning type of the ETWS primary notification and provides information related to emergency user alerts and UE pop-up behaviour; and warningAreaCoordinates, which indicates the geographical area where the ETWS warning message is valid.

In ASN.1, type definitions and/or value definitions (e.g., constants) can be grouped within a construct referred to as a module. ASN.1 allows the definition of multiple modules, and type definitions and/or value definitions from one module can be imported by another module for use.

FIG. 4 illustrates an example ASN.1 structure in accordance with aspects of the present disclosure. In the example of FIG. 4, the ASN.1 structure is a current ASN.1 structure in 5G and consists of six modules. A first module, NR-RRC-Definitions, contains the RRC message (PDU) and IE definitions used for the Uu-interface. A second module, PC5-RRC-Definitions, contains the RRC message (PDU) and IE definitions used for the PC5-interface. A third module, NR-UE-Variables, contains the RRC IEs used in UE variables. A fourth module, NR-InterNodeDefinitions, contains the RRC messages (PDUs) transferred between network nodes (e.g., NEs). A fifth module, NR-Sidelink-Preconf, contains the RRC IEs for pre-configured sidelink parameters used for sidelink communication. A sixth module, NR-Sidelink-DiscoveryMessage, contains the RRC IEs transferred in discovery messages.

The main module, NR-RRC-Definitions, servers as the source from which all other modules import the necessary IEs and constants. A substantial drawback of the current ASN.1 structure is that all UEs are required to compile the entire main module even when supporting only a subset of the features defined in the main module. The introduction of new features has progressively increased the size of the main module, such that the main module may occupy several megabytes of memory. As a consequence, some RRC messages may include a substantial amount of overhead and, in some cases, exceed the RRC PDU size limit of 9000 octets. In such cases, the RRC messages are segmented into multiple segments (messages), each having a size of 9000 octets or less. Examples of RRC messages that may exceed the size limit of 9000 octets include, but is not limited to, RRCReconfiguration, RRCResume and UECapabilityInformation.

Returning to FIG. 1, each of the NE 102 and the UE 104 may be configured with a protocol stack, which may include one or more protocol layers, such as an RRC protocol layer, a PDCP protocol layer, an RLC protocol layer, a MAC protocol layer, and PHY protocol layer. The RRC protocol layer may support broadcast of system information, paging, RRC connection control, Access Stratum (AS) security, mobility, QoS management, Non-Access Stratum (NAS) message transfer, segmentation, measurement configuration and reporting, detection of and recovery from radio link failure (RLF), and the like. The PDCP protocol layer may support transfer of C-plane data, header compression, ciphering, and integrity protection. The RLC protocol layer may support transfer of upper layer PDUs, segmentation, and Automatic Repeat Request (ARQ). The MAC protocol layer may support mapping between logical channels and transport channels, multiplexing of MAC Service Data Units (SDUs) belonging to one or different logical channels into Transport Blocks (TB) delivered to the PHY protocol layer, Hybrid Automatic Repeat Request (HARQ), and priority handling. The PHY protocol layer may support channel coding, error detection, modulation, frequency and time synchronisation, and measurements. An SDU may refer to a data unit that is transmitted (e.g., outputted) and/or received (e.g., obtained) by a sub-protocol layer (e.g., another protocol layer within a same protocol layer, such as a L2) from or to a higher sub-protocol layer (e.g., Layer 3 (L3)). Likewise, a PDU may refer to a data unit that is transmitted (e.g., outputted) and/or received (e.g., obtained) by a sub-protocol layer (e.g., L3, L2) to or from a lower sub-protocol layer (e.g., Layer 1 (L1) or L2).

To manage a connection between an NE 102 and a UE 104, various RRC messages may be utilized. Examples of such messages include: MeasurementReport, an uplink (UL) message used to indicate of measurement results; RRCReconfiguration, a DL message used to modify an RRC connection and to convey information for measurement configuration, mobility control, radio resource configuration (including radio bearers (RBs), MAC main configuration, and physical channel configuration), and AS security configuration; RRCRelease, a DL message used to command the release or suspension of an RRC connection; RRCResume, a DL message used to resume a suspended RRC connection; RRCSetup, a DL message used to establish a dedicated signalling connection; RRCSetupRequest, an UL message used to request establishment of an RRC connection; SystemInformation, a DL message used to convey one or more SIBs or positioning SIBs (posSIBs); UEAssistanceInformation, an UL message used to indicate of UE assistance information to the NE 102; UECapabilityEnquiry, a DL message used to request UE capabilities for one or more radio access technologies; and UECapabilityInformation, an UL message used to indicate UE capabilities requested by the NE 102.

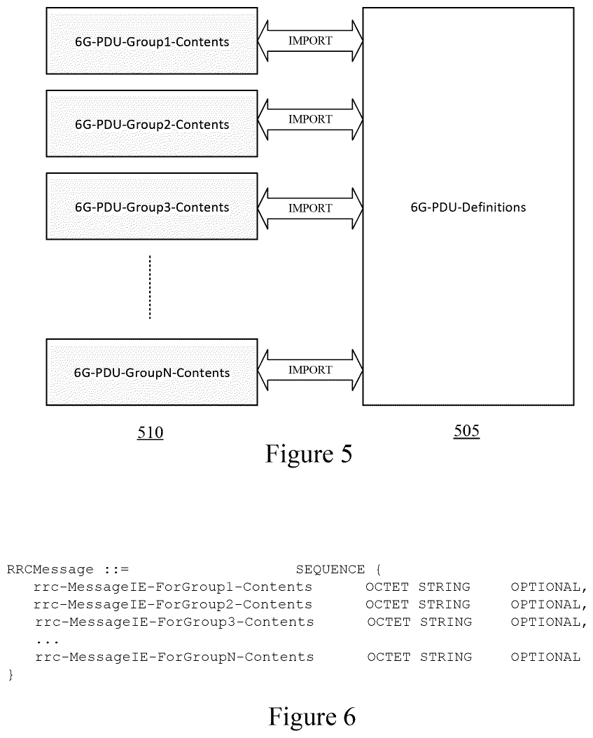

FIG. 5 illustrates an example of a modular ASN.1 structure in accordance with aspects of the present disclosure. The modular ASN.1 structure includes a module 505 (also referred to as a “main module”, “primary module” or “common module”) and a set of one or more sub-modules 510. In the example of FIG. 5, the module 505, labeled 6G-PDU-Definitions, serves as a primary module that may contain definitions of RRC messages for both UL and DL transmissions, and IEs that are common for UEs 104 irrespective of UE-specific features supported by the UEs 104. As such, the module 505 may include definitions of RRC messages and IEs applicable to all UEs 104 (e.g., in the wireless communication system 100 supporting 6G) configured to support wireless communication with the NE 102 (e.g., base station). In some implementations, the module 505 may include definitions and IEs associated with acquisition of system information, RRC connection establishment, radio resource configuration and reconfiguration, RRC connection release, and UE capability information transfer.

The sub-modules 510 may be organized as a set of N sub-modules, denoted 6G-PDU-GroupX-Contents, where X ranges from 1 to N. Each sub-module 510 may contain IEs that are specific to a group of 6G UE-specific features, and that are used by the UEs 104 supporting those UE-specific features. In some implementations, a sub-module 510 may include definitions of RRC messages associated with the corresponding group of 6G UE-specific features. The content of each sub-module 510 may be defined based on features applicable to a UE 104. Such features may include, for example, a type of feature supported by the UE 104 (e.g., an ML-enabled feature, intra-band CA, inter-band CA, MIMO-enabled transmission or reception, intra-RAT mobility, inter-RAT mobility, a channel bandwidth, a modulation order, a number of MIMO layers, or a TB size), an RRC state (e.g., idle mode, inactive mode (e.g., power saving mode), connected mode), UE device type (e.g., cellular telephone, IoT device, UAV), communication cast type (e.g., broadcast, groupcast, unicast), RAT (e.g., 4G, 5G, 6G, or other suitable RATs), or any combination thereof. To enable forward compatibility, any new feature introduced in future releases may be defined either as a separate sub-module 510 (e.g., 6G-PDU-GroupX-Contents) or incorporated into an existing sub-module 510. Similarly, enhancements to 6G features introduced after a sub-module 510 is created, and are related to the sub-module 510, may be incorporated into the corresponding sub-module 510.

The import of IEs between the module 505 and one or more sub-modules 510 can be unidirectional or bidirectional. In some implementations, the module 505 may import IEs from one or more sub-module 510, one or more sub-module 510 may import IEs from the module 505, or both. Additionally, to reduce redundancy in the definition of the sub-modules 510, a unidirectional or bidirectional import of IEs between the sub-modules 510 themselves may be defined.

Accordingly, the modular ASN.1 structure may generate an RRC message, which may have a reduced size compared to conventional RRC messages and mitigate segmentation of the RRC message. The NE 102 and the UE 104 may thereby experience signaling efficiency, reduced processing, and power saving associated with processing of such an RRC message.

FIG. 6 illustrates an example of an RRC message in accordance with aspects of the present disclosure. With reference to the modular ASN.1 of FIG. 5, an RRC message defined by the module 505 may include a SEQUENCE of one or more sub-module-specific components corresponding to the RRC message. In the example of FIG. 6, each component of the RRC message is defined as an OCTET STRING that contains a sub-module-specific IE. For example, the OCTET STRING corresponding to component rrc-MessageIE-ForGroup1-Contents contains the IE defined in the 6G-PDU-Group1-Contents sub-module 510, while the OCTET STRING corresponding to component rrc-MessageIE-ForGroup2-Contents contains the IE defined in the 6G-PDU-Group2-Contents sub-module 510. Additional components may likewise be defined for other features groups.

In some implementations, only a subset of the RRC message defined in the module 505 are defined in a sub-module-specific manner, as shown in FIG. 6. For example, in one implementation, only RRC messages that have a large size (e.g., greater than or equal to a threshold size), such as RRCReconfiguration and UECapabilityInformation may use an efficient RRC message type (e.g., format), while other messages may use a different message type (e.g., format) that is not divided into sub-module-specific contents.

The term OPTIONAL, as shown in FIG. 6, indicates that each sub-module-specific content is not necessarily present in each RRC message. In some implementations, an NE 102 may transmit RRC messages to a set of UEs 104 that share UE-specific features associated with a particular sub-module, and not transmit those messages to other UEs that do not share the UE-specific features. In such cases, the RRC message may include only the sub-module contents corresponding to one or more sub-modules 510 that are shared (e.g., common) to the set of UEs 104. In other examples, if the Group3-Contents sub-module is defined for IoT UEs 104, the NE 102 may transmit an RRC message that includes the rrc-MessageIE-ForGroup3-Contents and excludes (e.g., omits) contents for other sub-modules to the IoT UEs 104. Accordingly, the overall size of the RRC message may be substantially reduced.

In some implementations, an NE 102 may generate an efficient RRC message after determining that an RRC message that would be otherwise transmitted to all UEs 104 would exceed a threshold size. For example, the NE 102 may determine whether the size of an RRC message satisfies (e.g., is greater than or equal to) a threshold size, and if so, generate and transmit an RRC message containing group-specific contents instead. The threshold size may be, for example, 9000 octets, although other threshold may be used in different implementations. Additionally, or alternatively, a UE 104 may generate and transmit an efficient RRC message to an NE 102 with only sub-module contents that are applicable to the UE 104. This may lead to significant power savings for the UE 104, such when the UE 104 is an IoT UE by reducing the overhead associated with RRC message generation and transmission. In some implementations, the UE 104 may determine whether a size of an RRC message satisfies (e.g., is greater than or equal to) a threshold size, and based in part on determining that the size of the RRC message satisfies the threshold size, the UE 104 may enable efficient RRC messaging.

In some implementations, the module 505 may contain common RRC messages for UL and/or DL, including, for example, RRCRelease, RRCSetup, RRCSetupRequest, and SystemInformation. In some implementations, each sub-module 510 may contain sub-module specific RRC messages for UL and/or DL that are applicable to UE-specific features such as RRCReconfiguration (e.g., for (re-)configure resources), RRCConfigurationRelease (e.g., for release radio resources), UEAssistanceInformation, UECapabilityEnquiry, and UECapabilityInformation. Each of these RRC messages may correspond to one or more UE-specific features associated with respective sub-modules 510.

Each RRC message may include an indication that identifies one or more sub-modules 510 that are applicable to the RRC message. The indication may be embedded within the body of the RRC message. For example, the RRC message illustrated in FIG. 6 includes an indication of sub-modules N corresponding to the GroupN-Contents within the RRC message. In other implementations, the indication may be embedded elsewhere within the RRC message, such as within the name of the RRC message. Other implementations are also possible.

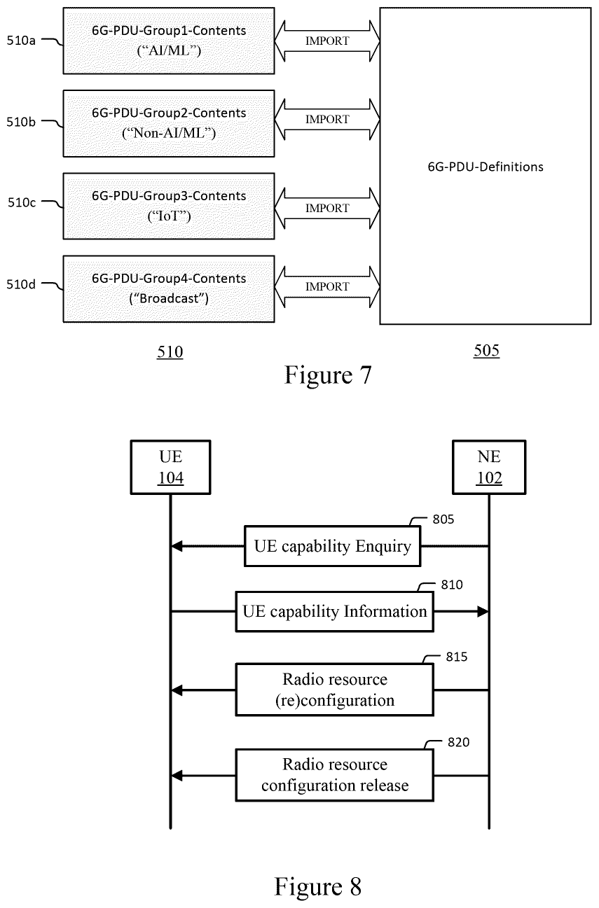

FIG. 7 illustrates an example of a modular ASN.1 structure in accordance with aspects of the present disclosure. In the example of FIG. 7, the modular ASN.1 structure includes five modules, one module 505 (also referred to as a main module) and four sub-modules 510. The module 505, labelled 6G-PDU-Definitions, contains the definitions of UL and DL RRC messages and IEs that are common to UEs 104, irrespective of the features these UEs 104 support. Examples of such RRC messages and IEs includes those used for acquisition of system information, RRC connection establishment, radio resource (re-)configuration, RRC connection release, and UE capability information transfer.

The first sub-module 510a, labelled 6G-PDU-Group1-Contents, is a sub-module 510 that contains IEs for operating an AI/ML-capable UEs 104 that support AI/ML-enabled features. Examples of AI/ML-enabled features may include beam management prediction, CSI measurement prediction, CSI measurement compression, handover failure prediction, Reference Signal Received Power (RSRP) prediction, RLF prediction, UL scheduling prediction with respect to UL buffer status, and UL data arrival. The second sub-module 510b, labelled 6G-PDU-Group2-Contents, is a sub-module 510 that contains IEs for operating a UE 104 that supports non-AI/ML-enabled features such as intra-band/inter-band CA, MIMO, intra-RAT mobility and inter-RAT mobility. The third sub-module 510c, labelled 6G-PDU-Group3-Contents, is a sub-module 510 that contains IEs for operating a low-complexity, low-cost IoT UE 104. These IEs may relate to parameters such as maximum channel bandwidth, modulation order, maximum MIMO layers in UL and/or DL, maximum TB size, etc. The fourth sub-module 510d, labelled 6G-PDU-Group4-Contents, is a sub-module 510 that contains IEs for acquisition of broadcast services, such as CMAS and ETWS messages.

A UE 104 may include processor-executable code, for example, code that is compiled from a modular ASN.1 structure, in accordance with the UE-specific features. The code may be compiled from the module 505 (i.e., a main ASN.1 module) and one or more sub-module 510 (e.g., by a device supplier) and stored on the UE 104 or compiled by the UE 104 itself. Additionally, an NE 102 may include processor-executable code that is compiled from the module 505 (i.e., a main ASN.1 module) and sub-modules 510. The code of the NE 102 may be compiled by a supplier and stored on the NE 102 or compiled by the NE 102 itself.

Returning to the example of FIG. 7, a first set of UEs 104 with AI/ML capabilities may store code compiled from the module 505 and code compiled from sub-modules 510a (Group1), 510b (Group2), and 510d (Group4). A second set of UEs 104 configured with advanced capabilities but lacking AI/ML capability may store code compiled from the module 505 and code compiled from sub-modules 510b (Group2) and 510d (Group4). A third set of UEs 104 that are low-complexity, low-cost IoT devices may store code compiled from the module 505 and code compiled from the sub-module 510c (Group3). A fourth set of UEs 104 that operative in receive-only mode may store code compiled from the module 505 and code from sub-module 510d (Group4).

As noted above, in this example, the NE 102 stores code compiled from the module 505 as well as code from each of the sub-modules 510 including sub-module 510a, sub-module 510b, sub-module 510c, and sub-module 510d.

FIG. 8 illustrates an example of a signaling diagram in accordance with aspects of the present disclosure. In some examples, the signaling diagram implements or is implemented by aspects of the wireless communications system 100. The signaling diagram may implement or be implemented by an NE 102 and a UE 104, which may be examples of an NE 102 and a UE 104 as described with reference to FIG. 1. The signaling diagram illustrates an example of sub-module specific RRC messaging. Alternative examples of the following may be implemented, where some operations and/or signaling are performed in a different order than described or are not performed. In some cases, operations and/or signaling may include additional features not mentioned below, or further operations and/or signaling may be added.

In the example of FIG. 8, the UE 104 may be in connected mode and have a dedicated RRC connection with the NE 102. To reconfigure resources that have been configured for the UE 104, the NE 102 may transmit a UE capability request message 805, such as a UECapabilityEnquiry message, to request capabilities that are supported by the UE 104. In response to the received request message 805, the UE 104 may transmit a UE capability information response message 810, such as a UECapabilityInformation message, to the NE 102.

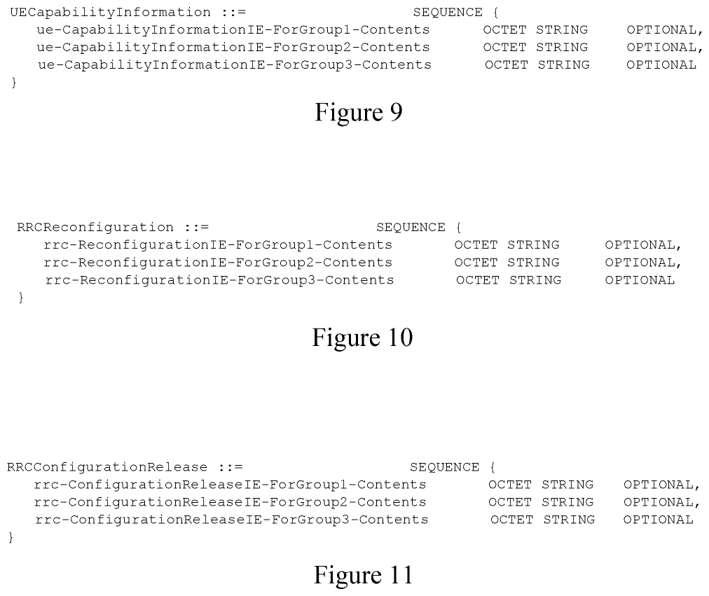

FIG. 9 illustrates an example of a UE capability information response message in accordance with aspects of the present disclosure. In some examples, the UE capability information response message may be the UECapabilityInformation message as described herein with reference to FIG. 8.

As described herein, common RRC messages such as RRCReconfiguration, RRCConfigurationRelease and UECapabilityInformation may be defined in a main module, and may be further defined as a SEQUENCE of sub-module-specific components within one or more sub-modules, which may significantly reduce message size and avoid segmentation of these messages. The RRCReconfiguration, RRCConfigurationRelease and UECapabilityInformation messages each include three components corresponding to the three 6G-PDU-GroupX-Contents sub0modules (where X=1, 2, or 3). Each component is defined as an OCTET STRING that contains the sub-module-specific IE. In accordance with an efficient RRC message, the NE 102 may transmit a sub-module-specific radio resource (re-)configuration message 815 to the UE 104 via the RRCReconfiguration message, and a sub-module-specific radio resource configuration release message 820 to the UE 104 via the RRCConfigurationRelease message. Likewise, the UE 104 may transmit a sub-module-specific UE capability information message 810 to the NE 102 via the UECapabilityInformation message.

With reference to FIGS. 8 and 9, for advanced and AI/ML-capable UEs 104, a UE capability information message 810 (e.g., the UECapabilityInformation message) may include the components ue-CapabilityInformationIE-ForGroup1-Contents and ue-CapabilityInformationIE-ForGroup2-Contents. For advanced but not AI/ML-capable UEs 104, the UECapabilityInformation message may include only the component ue-CapabilityInformationIE-ForGroup2-Contents. For low-complexity, low-cost IoT UEs 104, the UECapabilityInformation message may include only the component ue-CapabilityInformationIE-ForGroup3-Contents. The NE 102 may reconfigure the resources for the UE 104 based at least in part on the UE capability information message 810 by transmitting a radio resource (re)configuration message 815 to the UE 104.

FIG. 10 illustrates an example of a radio resource (re)configuration message in accordance with aspects of the present disclosure. In some examples, the radio resource (re)configuration message may be the radio resource (re)configuration message 815 as described herein with reference to FIG. 8, and an example of an RRCReconfiguration message. For advanced and AI/ML-capable UEs 104, the RRCReconfiguration message may include the components rrc-ReconfigurationIE-ForGroup1-Contents and rrc-ReconfigurationIE-ForGroup2-Contents. For advanced but not AI/ML-capable UEs 104 the RRCReconfiguration message may include only the component rrc-ReconfigurationIE-ForGroup2-Contents. For low-complexity, low-cost IoT UEs 104 the RRCReconfiguration message may include only the component rrc-ReconfigurationIE-ForGroup3-Contents. Subsequently, the NE 102 may release the resources that have been configured to the UE 104 by transmitting a radio resource configuration release message 820 to the UE 104.

FIG. 11 illustrates an example of a radio resource configuration release message in accordance with aspects of the present disclosure. In some examples, the radio resource configuration release message may be the radio resource configuration release message 820 as described herein with reference to FIG. 8, and an example of an RRCConfigurationRelease message. For advanced and AI/ML-capable UEs 104 the RRCConfigurationRelease message may include the components rrc-ConfigurationReleaseIE-ForGroup1-Contents and rrc-ConfigurationReleaseIE-ForGroup2-Contents. For advanced but not AI/ML-capable UEs 104 the RRCConfigurationRelease message may include only the component rrc-ConfigurationReleaseIE-ForGroup2-Contents. For low-complexity, low-cost IoT UEs 104 the RRCConfigurationRelease message may include only the component rrc-ConfigurationReleaseIE-ForGroup3-Contents.

In some implementations, a UE 104 is configured to transmit, to an NE 102, a message which includes information respective to the one or more features applicable to the UE 104, and excludes other information respective to one or more features inapplicable to the UE 104, e.g., information corresponding to an ASN.1 sub-module that is not supported by the UE 104. If a UE 104 receives a message from an NE 102 in which information respective to the one or more features applicable to the UE 104, and associated with the one or more ASN.1 sub-modules supported by the UE, is absent from the message, the UE 104 may discard the message. For example, if the UE 104 is an IoT device and receives a message from an NE 102 that does not include information for IoT features, the UE 104 may discard that message.

When generating an RRC message, e.g., a UECapabilityInformation message, a UE 104 may select information associated with one or more ASN.1 sub-modules based at least in part on the one or more features applicable to the UE 104. For example, referring to FIG. 9, the UE 104 may select the Group contents corresponding to one or more ASN.1 sub-modules configured at the UE, and the message may be generated based at least in part on the information associated with the selected one or more ASN.1 sub-modules. With respect to the UECapabilityInformation message, the UE 104 may determine UE capability information, and the information associated with the one or more ASN.1 sub-modules is selected based at least in part on the UE capability information. The UE 104 may receive an RRC message from the NE 102 that is based at least in part on the UE capability information 810. For example, the RRC message from the NE 102 may include information respective to sub-modules which are associated with the UE capability information.

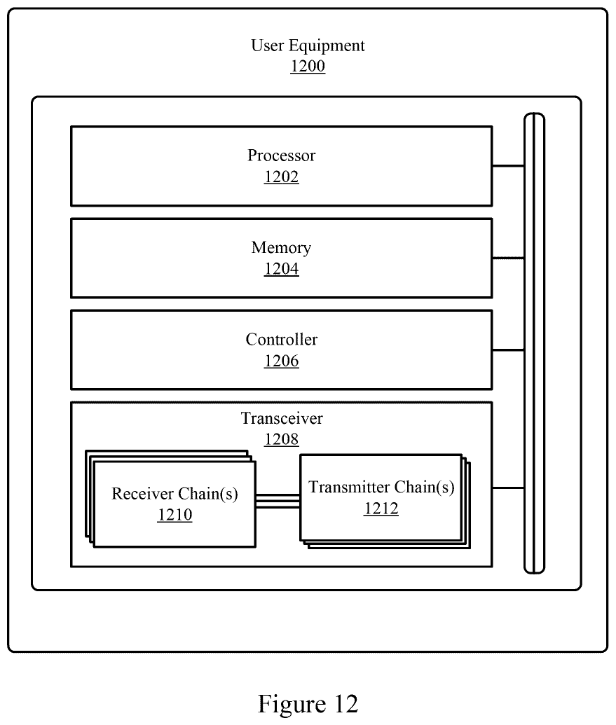

FIG. 12 illustrates an example of a UE 1200 in accordance with aspects of the present disclosure. The UE 1200 may include a processor 1202, a memory 1204, a controller 1206, and a transceiver 1208. The processor 1202, the memory 1204, the controller 1206, or the transceiver 1208, or various combinations thereof or various components thereof may be examples of means for performing various aspects of the present disclosure as described herein. These components may be coupled (e.g., operatively, communicatively, functionally, electronically, electrically) via one or more interfaces.

The processor 1202, the memory 1204, the controller 1206, or the transceiver 1208, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 1202 may include an intelligent hardware device (e.g., a general-purpose processor, a DSP, a CPU, an ASIC, an FPGA, or any combination thereof). In some implementations, the processor 1202 may be configured to operate the memory 1204. In some other implementations, the memory 1204 may be integrated into the processor 1202. The processor 1202 may be configured to execute computer-readable instructions stored in the memory 1204 to cause the UE 1200 to perform various functions of the present disclosure.

The memory 1204 may include volatile or non-volatile memory. The memory 1204 may store computer-readable, computer-executable code including instructions when executed by the processor 1202 cause the UE 1200 to perform various functions described herein. The code may be stored in a non-transitory computer-readable medium such the memory 1204 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1202 and the memory 1204 coupled with the processor 1202 may be configured to cause the UE 1200 to perform one or more of the functions described herein (e.g., executing, by the processor 1202, instructions stored in the memory 1204). For example, the processor 1202 may support wireless communication at the UE 1200 in accordance with examples as disclosed herein. The UE 1200 may be configured to support a means for generating, transmitting, and receiving modular ASN.1 messages.

The controller 1206 may manage input and output signals for the UE 1200. The controller 1206 may also manage peripherals not integrated into the UE 1200. In some implementations, the controller 1206 may utilize an operating system such as iOS®, ANDROID®, WINDOWS®, or other operating systems. In some implementations, the controller 1206 may be implemented as part of the processor 1202.

In some implementations, the UE 1200 may include at least one transceiver 1208. In some other implementations, the UE 1200 may have more than one transceiver 1208. The transceiver 1208 may represent a wireless transceiver. The transceiver 1208 may include one or more receiver chains 1210, one or more transmitter chains 1212, or a combination thereof.

A receiver chain 1210 may be configured to receive signals (e.g., control information, data, packets) over a wireless medium. For example, the receiver chain 1210 may include one or more antennas for receiving the signal over the air or wireless medium. The receiver chain 1210 may include at least one amplifier (e.g., a low-noise amplifier (LNA)) configured to amplify the received signal. The receiver chain 1210 may include at least one demodulator configured to demodulate the received signal and obtain the transmitted data by reversing the modulation technique applied during transmission of the signal. The receiver chain 1210 may include at least one decoder for decoding the demodulated signal to receive the transmitted data.

A transmitter chain 1212 may be configured to generate and transmit signals (e.g., control information, data, packets). The transmitter chain 1212 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 1212 may also include at least one power amplifier configured to amplify the modulated signal to an appropriate power level suitable for transmission over the wireless medium. The transmitter chain 1212 may also include one or more antennas for transmitting the amplified signal into the air or wireless medium.

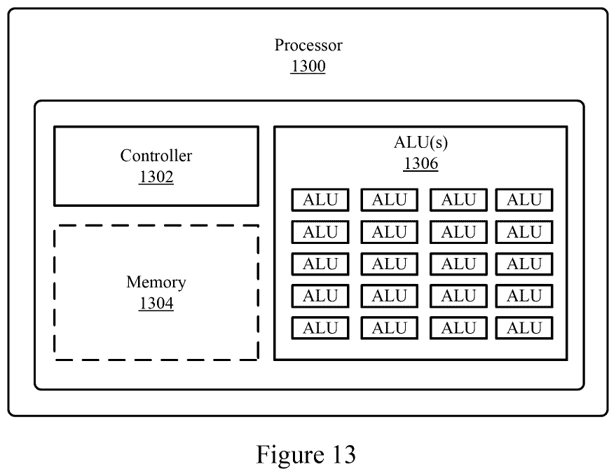

FIG. 13 illustrates an example of a processor 1300 in accordance with aspects of the present disclosure. The processor 1300 may be an example of a processor configured to perform various operations in accordance with examples as described herein. The processor 1300 may include a controller 1302 configured to perform various operations in accordance with examples as described herein. The processor 1300 may optionally include at least one memory 1304, which may be, for example, an L1/L2/L3 cache. Additionally, or alternatively, the processor 1300 may optionally include one or more arithmetic-logic units (ALUs) 1306. One or more of these components may be in electronic communication or otherwise coupled (e.g., operatively, communicatively, functionally, electronically, electrically) via one or more interfaces (e.g., buses).

The processor 1300 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 1300) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 1302 may be configured to manage and coordinate various operations (e.g., signaling, receiving, obtaining, retrieving, transmitting, outputting, forwarding, storing, determining, identifying, accessing, writing, reading) of the processor 1300 to cause the processor 1300 to support various operations in accordance with examples as described herein. For example, the controller 1302 may operate as a control unit of the processor 1300, generating control signals that manage the operation of various components of the processor 1300. These control signals include enabling or disabling functional units, selecting data paths, initiating memory access, and coordinating timing of operations.

The controller 1302 may be configured to fetch (e.g., obtain, retrieve, receive) instructions from the memory 1304 and determine subsequent instruction(s) to be executed to cause the processor 1300 to support various operations in accordance with examples as described herein. The controller 1302 may be configured to track memory address of instructions associated with the memory 1304. The controller 1302 may be configured to decode instructions to determine the operation to be performed and the operands involved. For example, the controller 1302 may be configured to interpret the instruction and determine control signals to be output to other components of the processor 1300 to cause the processor 1300 to support various operations in accordance with examples as described herein. Additionally, or alternatively, the controller 1302 may be configured to manage flow of data within the processor 1300. The controller 1302 may be configured to control transfer of data between registers, arithmetic logic units (ALUs), and other functional units of the processor 1300.

The memory 1304 may include one or more caches (e.g., memory local to or included in the processor 1300 or other memory, such RAM, ROM, DRAM, SDRAM, SRAM, MRAM, flash memory, etc. In some implementations, the memory 1304 may reside within or on a processor chipset (e.g., local to the processor 1300). In some other implementations, the memory 1304 may reside external to the processor chipset (e.g., remote to the processor 1300).

The memory 1304 may store computer-readable, computer-executable code including instructions that, when executed by the processor 1300, cause the processor 1300 to perform various functions described herein. The code may be stored in a non-transitory computer-readable medium such as system memory or another type of memory. The controller 1302 and/or the processor 1300 may be configured to execute computer-readable instructions stored in the memory 1304 to cause the processor 1300 to perform various functions. For example, the processor 1300 and/or the controller 1302 may be coupled with or to the memory 1304, the processor 1300, the controller 1302, and the memory 1304 may be configured to perform various functions described herein. In some examples, the processor 1300 may include multiple processors and the memory 1304 may include multiple memories. One or more of the multiple processors may be coupled with one or more of the multiple memories, which may, individually or collectively, be configured to perform various functions herein. For example, one or more of the multiple processors may be coupled with one or more of the multiple memories, which may, individually or collectively, be configured to generate, transmit, and receive modular ASN.1 messages.

The one or more ALUs 1306 may be configured to support various operations in accordance with examples as described herein. In some implementations, the one or more ALUs 1306 may reside within or on a processor chipset (e.g., the processor 1300). In some other implementations, the one or more ALUs 1306 may reside external to the processor chipset (e.g., the processor 1300). One or more ALUs 1306 may perform one or more computations such as addition, subtraction, multiplication, and division on data. For example, one or more ALUs 1306 may receive input operands and an operation code, which determines an operation to be executed. One or more ALUs 1306 be configured with a variety of logical and arithmetic circuits, including adders, subtractors, shifters, and logic gates, to process and manipulate the data according to the operation. Additionally, or alternatively, the one or more ALUs 1306 may support logical operations such as AND, OR, exclusive-OR (XOR), not-OR (NOR), and not-AND (NAND), enabling the one or more ALUs 1306 to handle conditional operations, comparisons, and bitwise operations.

The processor 1300 may support wireless communication in accordance with examples as disclosed herein. The processor 1300 may be configured to or operable to support a means for generating and receiving modular ASN.1 messages.

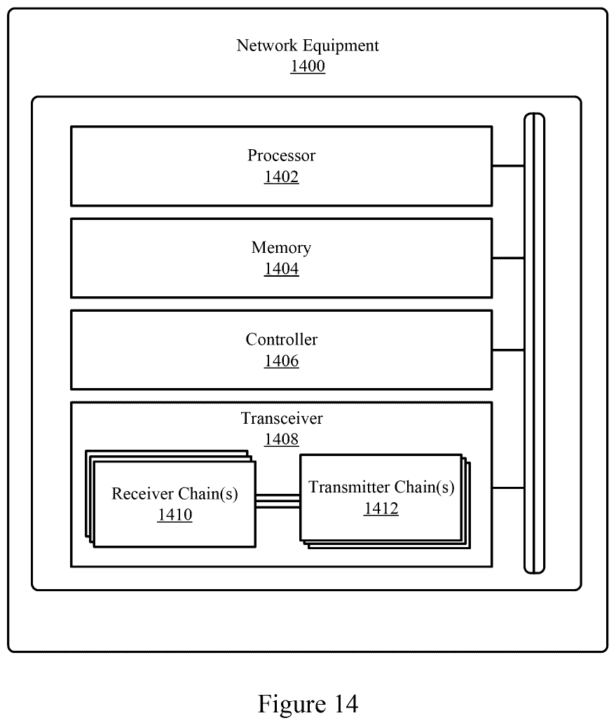

FIG. 14 illustrates an example of an NE 1400 in accordance with aspects of the present disclosure. The NE 1400 may include a processor 1402, a memory 1404, a controller 1406, and a transceiver 1408. The processor 1402, the memory 1404, the controller 1406, or the transceiver 1408, or various combinations thereof or various components thereof may be examples of means for performing various aspects of the present disclosure as described herein. These components may be coupled (e.g., operatively, communicatively, functionally, electronically, electrically) via one or more interfaces.

The processor 1402, the memory 1404, the controller 1406, or the transceiver 1408, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 1402 may include an intelligent hardware device (e.g., a general-purpose processor, a DSP, a CPU, an ASIC, an FPGA, or any combination thereof). In some implementations, the processor 1402 may be configured to operate the memory 1404. In some other implementations, the memory 1404 may be integrated into the processor 1402. The processor 1402 may be configured to execute computer-readable instructions stored in the memory 1404 to cause the NE 1400 to perform various functions of the present disclosure.

The memory 1404 may include volatile or non-volatile memory. The memory 1404 may store computer-readable, computer-executable code including instructions when executed by the processor 1402 cause the NE 1400 to perform various functions described herein. The code may be stored in a non-transitory computer-readable medium such the memory 1404 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1402 and the memory 1404 coupled with the processor 1402 may be configured to cause the NE 1400 to perform one or more of the functions described herein (e.g., executing, by the processor 1402, instructions stored in the memory 1404). For example, the processor 1402 may support wireless communication at the NE 1400 in accordance with examples as disclosed herein. The NE 1400 may be configured to support a means for generating, transmitting, and receiving modular ASN.1 messages.

The controller 1406 may manage input and output signals for the NE 1400. The controller 1406 may also manage peripherals not integrated into the NE 1400. In some implementations, the controller 1406 may utilize an operating system such as iOS®, ANDROID®, WINDOWS®, or other operating systems. In some implementations, the controller 1406 may be implemented as part of the processor 1402.

In some implementations, the NE 1400 may include at least one transceiver 1408. In some other implementations, the NE 1400 may have more than one transceiver 1408. The transceiver 1408 may represent a wireless transceiver. The transceiver 1408 may include one or more receiver chains 1410, one or more transmitter chains 1412, or a combination thereof.

A receiver chain 1410 may be configured to receive signals (e.g., control information, data, packets) over a wireless medium. For example, the receiver chain 1410 may include one or more antennas for receiving the signal over the air or a wireless medium. The receiver chain 1410 may include at least one amplifier (e.g., a low-noise amplifier (LNA)) configured to amplify the received signal. The receiver chain 1410 may include at least one demodulator configured to demodulate the received signal and obtain the transmitted data by reversing the modulation technique applied during transmission of the signal. The receiver chain 1410 may include at least one decoder for decoding the demodulated signal to receive the transmitted data.

A transmitter chain 1412 may be configured to generate and transmit signals (e.g., control information, data, packets). The transmitter chain 1412 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 1412 may also include at least one power amplifier configured to amplify the modulated signal to an appropriate power level suitable for transmission over the wireless medium. The transmitter chain 1412 may also include one or more antennas for transmitting the amplified signal into the air or wireless medium.

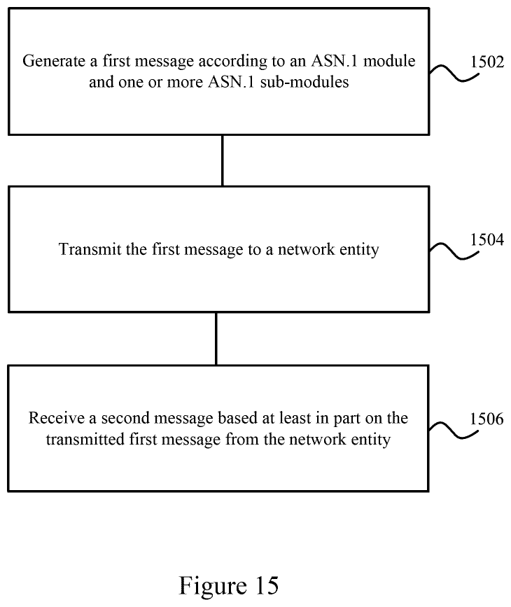

FIG. 15 illustrates a flowchart of a method in accordance with aspects of the present disclosure. The operations of the method may be implemented by a UE as described herein. In some implementations, the UE may execute a set of instructions to control the function elements of the UE to perform the described functions.

At 1502, the method may include generating a first message according to an ASN.1 module and one or more ASN.1 sub-modules. The ASN.1 module may include information irrespective of features applicable to the UE, and the one or more ASN.1 sub-modules may include information respective to one or more features applicable to the UE. By generating the first message according to the one or more ASN.1 sub-modules, which may include information respective to one or more features applicable to the UE, the UE may support techniques for reduced signaling overhead and decreased processing associated with the first message. The operations of 1502 may be performed in accordance with examples as described herein. In some implementations, aspects of the operations of 1502 may be performed by a UE as described with reference to FIG. 12.

At 1504, the method may include transmitting the first message to a network entity. The operations of 1504 may be performed in accordance with examples as described herein. In some implementations, aspects of the operations of 1504 may be performed by a UE as described with reference to FIG. 12.

At 1506, the method may include receiving a second message based at least in part on the transmitted first message from the network entity. The operations of 1506 may be performed in accordance with examples as described herein. In some implementations, aspects of the operations of 1506 may be performed a UE as described with reference to FIG. 12.

It should be noted that the method described herein describes a possible implementation, and that the operations and the steps may be rearranged or otherwise modified and that other implementations are possible.

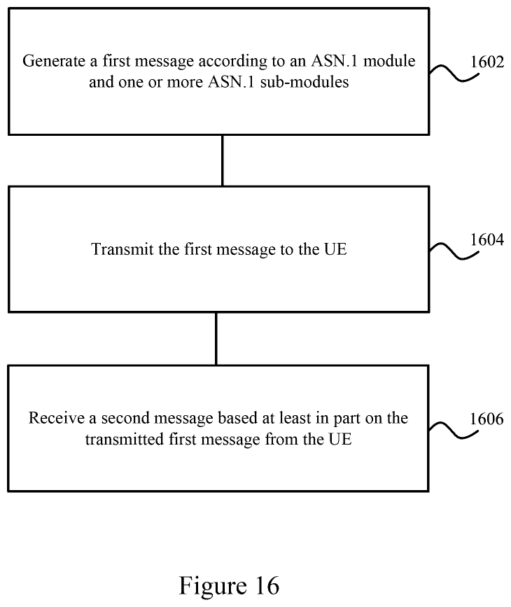

FIG. 16 illustrates a flowchart of a method in accordance with aspects of the present disclosure. The operations of the method may be implemented by an NE (e.g., a base station) as described herein. In some implementations, the NE may execute a set of instructions to control the function elements of the NE to perform the described functions.

At 1602, the method may include generating a first message according to an ASN.1 module and one or more ASN.1 sub-modules. The ASN.1 module may include information irrespective of features applicable to a UE, and the one or more ASN.1 sub-modules may include information respective to one or more features applicable to the UE. By generating the first message according to the one or more ASN.1 sub-modules, which may include information respective to one or more features applicable to the UE, the NE may support techniques for reduced signaling overhead and decreased processing associated with the first message. The operations of 1602 may be performed in accordance with examples as described herein. In some implementations, aspects of the operations of 1602 may be performed by an NE as described with reference to FIG. 14.

At 1604, the method may include transmitting the first message to the UE. The operations of 1604 may be performed in accordance with examples as described herein. In some implementations, aspects of the operations of 1604 may be performed by an NE as described with reference to FIG. 14.

At 1606, the method may include receiving a second message based at least in part on the transmitted first message from the UE. The operations of 1606 may be performed in accordance with examples as described herein. In some implementations, aspects of the operations of 1606 may be performed an NE as described with reference to FIG. 14.

It should be noted that the method described herein describes a possible implementation, and that the operations and the steps may be rearranged or otherwise modified and that other implementations are possible.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE) for wireless communication, comprising:
one or more memories storing processor-executable code; and
one or more processors coupled with the one or more memories and individually or collectively operable to execute the code to cause the UE to:
generate a first message according to an Abstract Syntax Notation One (ASN.1) module and one or more ASN.1 sub-modules, wherein the ASN.1 module comprises information irrespective of features applicable to the UE, and wherein the one or more ASN.1 sub-modules comprises information respective to one or more features applicable to the UE;
transmit, to a network entity, the first message, wherein the first message includes information respective to the one or more features applicable to the UE and excludes other information respective to one or more features inapplicable to the UE; and
receive, from the network entity, a second message based at least in part on the transmitted first message.

2. The UE of claim 1, wherein the received second message includes the information respective to the one or more features applicable to the UE and excludes other information respective to the one or more features inapplicable to the UE.

3. The UE of claim 1, wherein the one or more processors are individually or collectively operable to execute the code to cause the UE to:
determine that the information respective to the one or more features applicable to the UE, and associated with the one or more ASN.1 sub-modules, is absent from the second message; and
discard the second message in response to the determination.

4. The UE of claim 1, wherein the one or more processors are individually or collectively further operable to execute the code to cause the UE to:
select information associated with the one or more ASN.1 sub-modules based at least in part on the one or more features applicable to the UE,
wherein the first message is generated based at least in part on the information associated with the selected one or more ASN.1 sub-modules.

5. The UE of claim 4, wherein the one or more processors are individually or collectively further operable to execute the code to cause the UE to:
determine UE capability information, wherein the information associated with the one or more ASN.1 sub-modules is selected based at least in part on the UE capability information, and
wherein the second message is based at least in part on the UE capability information.

6. The UE of claim 1, further comprising:
a protocol stack comprising processor-executable code, wherein the protocol stack comprises at least a Radio Resource Control (RRC) protocol layer, and wherein, to generate the first message, the one or more processors are individually or collectively operable to execute the code to cause the RRC protocol layer of the UE to:
generate the first message according to the ASN.1 module and the one or more ASN.1 sub-modules.

7. The UE of claim 1, wherein the ASN.1 module comprising information irrespective of the one or more features applicable to the UE corresponds to definitions of messages and Information Elements (IEs) common for UEs.

8. The UE of claim 1, wherein the one or more features applicable to the UE and associated with the one or more sub-modules comprises one or more of:
a set of one or more UE-specific features supported by the UE;
a set of one or more modes of the UE, including at least one of an idle mode, an inactive mode, or a connected mode;
a type of the UE;
a cast type supported by the UE, including at least one of unicast, multicast, or broadcast; and
a radio access technology (RAT) supported by the UE.

9. The UE of claim 8, wherein the set of one or more UE-specific features supported by the UE comprises one or more of a machine learning (ML)-enabled feature, intra-band Carrier Aggregation (CA), inter-band CA, Multiple Input Multiple Output (MIMO)-enabled transmission or reception, intra-Radio Access Technology (RAT) mobility, inter-RAT mobility, a channel bandwidth, a modulation order, a number of MIMO layers, or a Transport Block (TB) size.

10. The UE of claim 1, wherein one or more of the first message and the second message associated with the ASN.1 module includes RRCRelease, RRCSetup, or SystemInformation, and wherein one or more of the first message and the second message associated with the one or more ASN.1 sub-modules includes RRCReconfiguration, RRCConfigurationRelease, or UECapabilityInformation.

11. The UE of claim 1, wherein the first message includes a first indication of the one or more ASN.1 sub-modules, and wherein the second message includes a second indication of the one or more ASN.1 sub-modules.

12. A method performed by a user equipment (UE), the method comprising:
generating a first message according to an Abstract Syntax Notation One (ASN.1) module and one or more ASN.1 sub-modules, wherein the ASN.1 module comprises information irrespective of features applicable to the UE, and wherein the one or more ASN.1 sub-modules comprises information respective to one or more features applicable to the UE;
transmitting, to a network entity, the first message, wherein the first message includes information respective to the one or more features applicable to the UE and excludes other information respective to one or more features inapplicable to the UE; and
receiving, from the network entity, a second message based at least in part on the transmitted first message.

13. The method of claim 12, wherein the received second message includes the information respective to the one or more features applicable to the UE and excludes other information respective to the one or more features inapplicable to the UE.

14. The method of claim 12, further comprising:
determining that the information respective to the one or more features applicable to the UE, and associated with the one or more ASN.1 sub-modules, is absent from the second message; and
discarding the second message in response to the determination.

15. The method of claim 12, further comprising:
selecting information associated with the one or more ASN.1 sub-modules based at least in part on the one or more features applicable to the UE,
wherein the first message is generated based at least in part on the information associated with the selected one or more ASN.1 sub-modules.

16. The method of claim 15, further comprising:
determining UE capability information, wherein the information associated with the one or more ASN.1 sub-modules is selected based at least in part on the UE capability information, and
wherein the second message is based at least in part on the UE capability information.

17. The method of claim 12, wherein the ASN.1 module comprising information irrespective of the one or more features applicable to the UE corresponds to definitions of messages and Information Elements (IEs) common for UEs.

18. The method of claim 12, wherein the one or more features applicable to the UE and associated with the one or more sub-modules comprises one or more of:
a set of one or more UE-specific features supported by the UE;
a set of one or more modes of the UE, including at least one of an idle mode, an inactive mode, or a connected mode;
a type of the UE;
a cast type supported by the UE, including at least one of unicast, multicast, or broadcast; and
a radio access technology (RAT) supported by the UE.

19. A network equipment (NE) for wireless communication, comprising:
one or more memories storing processor-executable code; and
one or more processors coupled with the one or more memories and individually or collectively operable to execute the code to cause the NE to:
generate a first message according to an Abstract Syntax Notation One (ASN.1) module and one or more ASN.1 sub-modules, wherein the ASN.1 module comprises information irrespective of features applicable to a user equipment (UE), and wherein the one or more ASN.1 sub-modules comprises information respective to one or more features applicable to the UE;
transmit, to the UE, the first message, wherein the first message includes information respective to the one or more features applicable to the UE and excludes other information respective to one or more features inapplicable to the UE; and
receive, from the UE, a second message based at least in part on the transmitted first message.

20. The NE of claim 19, wherein the processor-executable code stored by the NE includes code for a plurality of sub-modules, and
wherein the one or more processors are individually or collectively further operable to execute the code to cause the NE to:
select the one or more sub-modules from the plurality of sub-modules based on the one or more features applicable to the UE.
